(19) United States
(12) Patent Application Publication
(10) Pub. No.: US 2004/0006910 A1
(43) Pub. Date: Jan. 15, 2004

(54) Cockroach-preventing seat

(76) Inventor: Chien-Yu Lee, Taipei (TW)

Correspondence Address: Chien-Yu Lee, 235 Chung - Ho, Box 8-24, Taipei, TW

(21) Appl. No.: 10/194,539

(22) Filed: Jul. 15, 2002

(51) Int. Cl. A01M 23/38; H05C 3/00; A01M 19/00

(52) U.S. Cl. 43/98

(57) ABSTRACT

A cockroach-preventing seat comprises a seat body and a cover. A bottom of the seat has a plurality of legs. The periphery of each leg is formed with a plurality of stepped surfaces around the leg. A plurality of conductive pieces are installed around each legs. The conductive pieces are locked to the stepped surfaces. At least one selected leg of the legs is hollowed and internal thereof has a plunge. When an electric device is placed upon the cover; a power wire of the electric device passes through the cover and through a central hole of the plug so as to be clamped therein. Then the plug is inserted into the selected leg so that the power wire is out of the bottom of the selected leg. Thereby, by the design of the leg and the plug, cockroaches will not enter into the seat body along the electric wire.

### FIELD OF THE INVENTION

The present invention relates to cockroach-preventing seats, and particularly to a cockroach-preventing seat which can improve many defects in the prior art.

### BACKGROUND OF THE INVENTION

Some prior art cockroach-preventing seats are disclosed in U.S. Pat. No. 6,018,904 and Taiwan Patent No. 86208004A01, assigned to the applicant of the present invention. In '904, referring to FIG. 1, the leg of the seat is arranged with coils having positive and negative electrodes. When the coils are conductive, cockroaches run through the legs will get an electric shock. The coils are covered by covers so as not to be touched by peoples. Thereby, cockroaches can not run into the seat body to pollute foods or objects. However, the structure of this prior art is not steadily and thus it can not support a heavy object. Moreover, a long time is necessary for winding the coil and thus the manufacturing amount is low and the cost is high. In the patent No. 86208001A01, referring to FIG. 2, a plurality of conductive pieces spaced with an equal space are arranged around the periphery of the legs. The conductive pieces are arranged around the legs and the terminals of the piece pass through the through hole at the bottom plate of the seat and are bent properly. The conductive pieces are buckled to the bottom surface of the bottom plate of the seat body and power is conductive into the terminal. However, this prior art has the following disadvantages:

1. The conductive pieces are punched with a plurality of terminals. The edges of the conductive piece adjacent to the terminals are very thin and thus the conductive pieces easily deform and thus the yield ratio is low. When the terminals insert into the bottom plate of the seat body and are bent for buckling to the bottom surface of the bottom plate, the positioning effect is not preferred. After it is used for a longer time, the terminal will become loose.

2. The conductive pieces are concentric and are spaced with predetermined lengths for insulation. When the conductive pieces are punched, a large amount waste materials are generated form maintaining the predetermined spaces.

### SUMMARY OF THE INVENTION

Accordingly, the primary object of the present invention is to provide a cockroach-preventing seat, wherein a plurality of stepped surfaces are arranged around the legs and thus conductive pieces can be installed on the stepped surfaces and the conductive pieces are spaced longitudinally for preventing cockroaches to go into the cockroach-preventing seat.

Another object of the present invention is to provide a cockroach-preventing seat, wherein conductive piece is made by punching once and thus the waste material is reduced greatly.

Another object of the present invention is to provide a cockroach-preventing seat, wherein a plurality of legs are formed at a bottom of the seat and one of the leg is hollow for receiving a plug. Electric wires are connected to the plug so as to prevent cockroaches to run through the electric wire to the cockroach-preventing seat.

To achieve above object, the present invention provides a cockroach-preventing seat comprising a seat and a cover. A bottom of the seat has a plurality of legs. The periphery of each leg is formed with a plurality of stepped surfaces around the leg. A plurality of conductive pieces are installed around each legs. The conductive pieces are locked to the stepped surfaces. At least one selected leg of the legs is hollowed and internal thereof has a plunge. When an electric device is placed upon the cover; a power wire of the electric device passes through a slot of the cover and through a central hole of the plug so as to be clamped therein. Then the plug is inserted into the selected leg in force so that the power wire is out of the bottom of the selected leg. Thereby, by the design of the leg and the plug, cockroaches will not enter into the seat.

The various objects and advantages of the present invention will be more readily understood from the following detailed description when read in conjunction with the appended drawing.

### BRIEF DESCRIPTION OF THE DRAWINGS

FIG. 1 is an exploded perspective view of one prior art.

FIG. 2 is an exploded perspective view of another prior art.

FIG. 3 is an exploded perspective view of the present invention.

FIG. 4 is an assembled schematic view of the present invention.

FIG. 5 is a perspective view of the present invention.

FIG. 6 is a cross section view along I-I′ of FIG. 4.

FIG. 7 is a cross section view along II-II′ of FIG. 4.

FIG. 8 shows one application of the present invention, where the present invention is used to place food.

FIG. 9 shows one application of the present invention, where the present invention is used to electric devices.

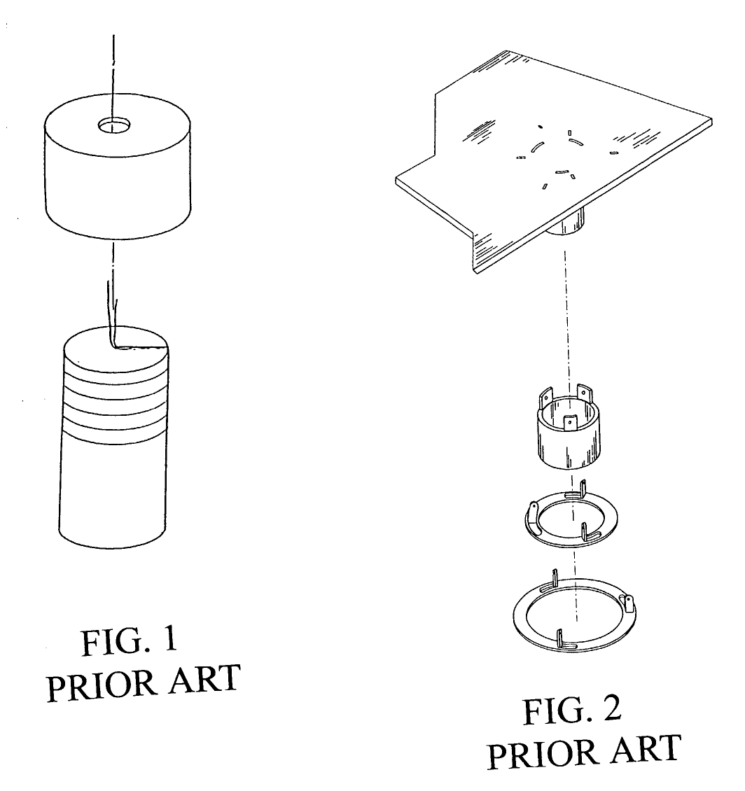

### DETAILED DESCRIPTION OF THE PREFERRED EMBODIMENTS

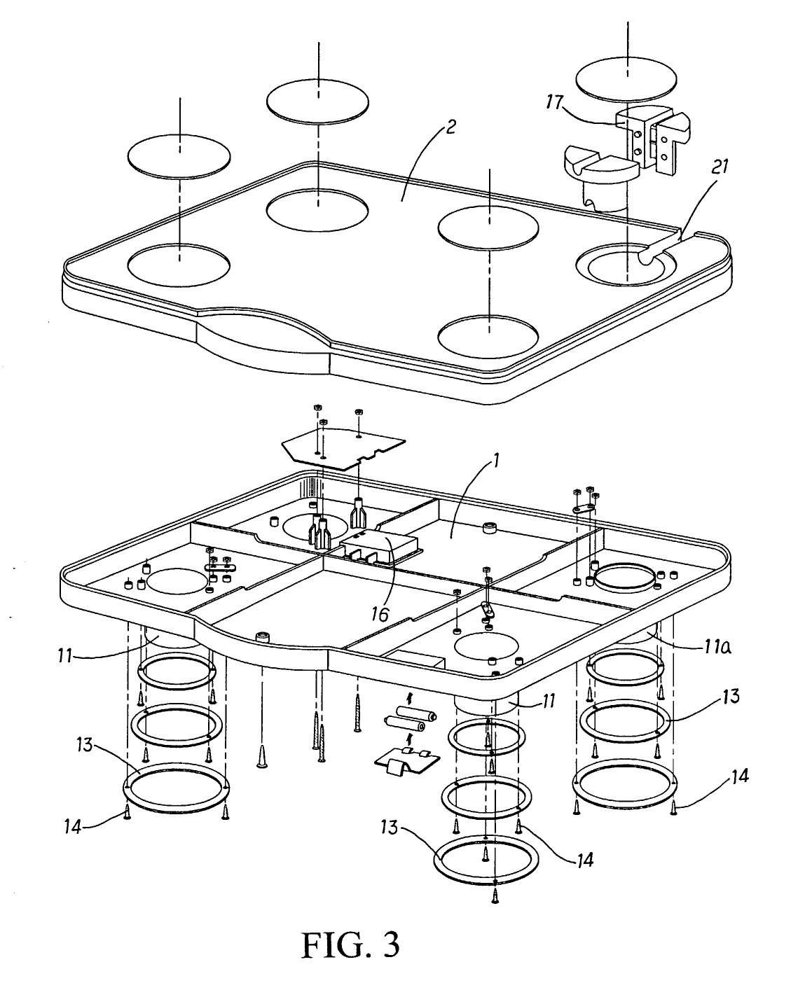

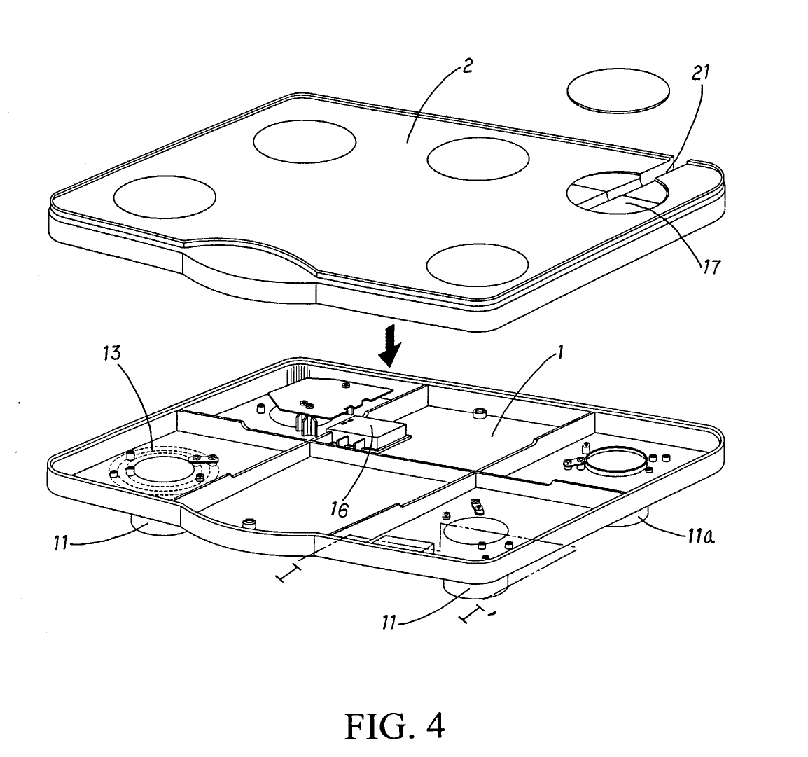

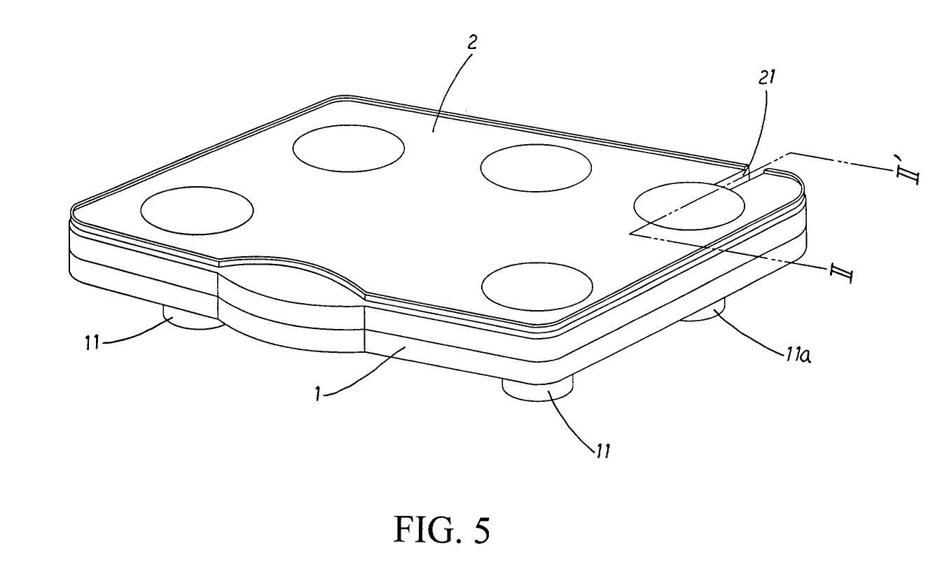

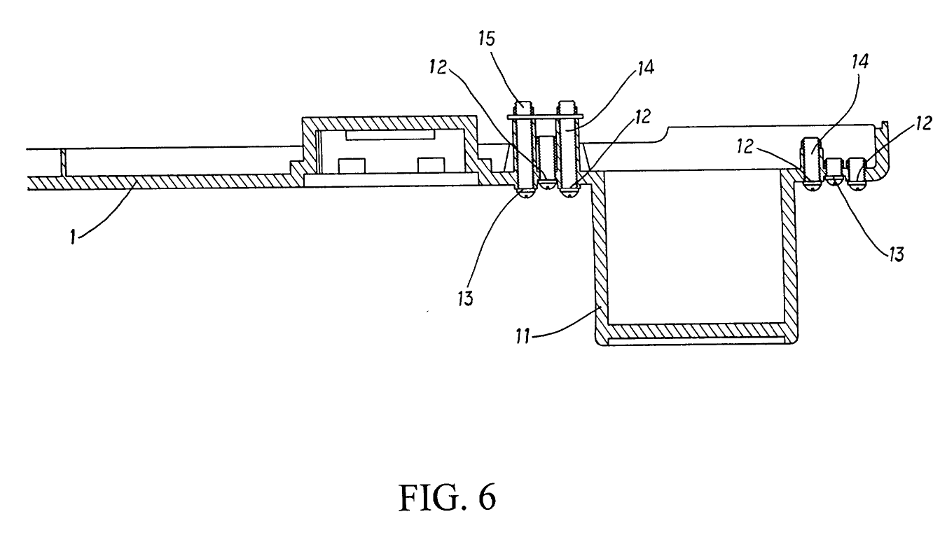

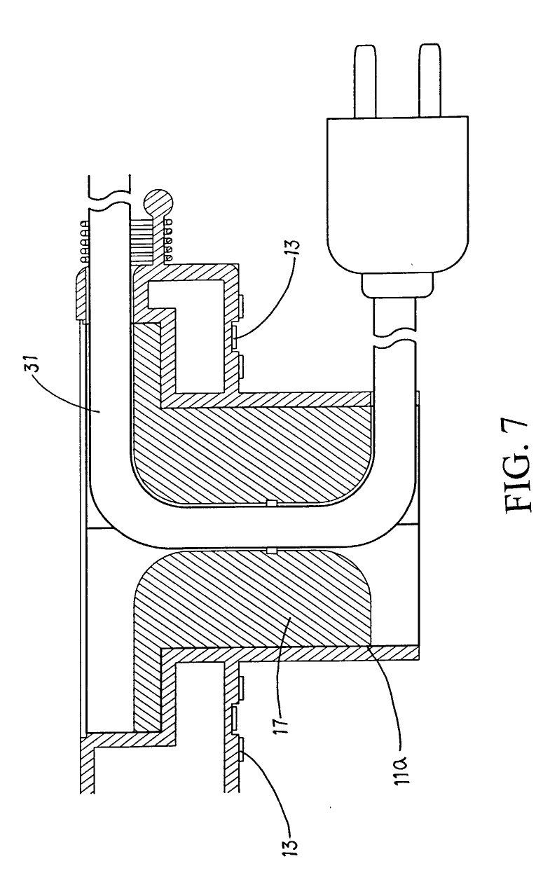

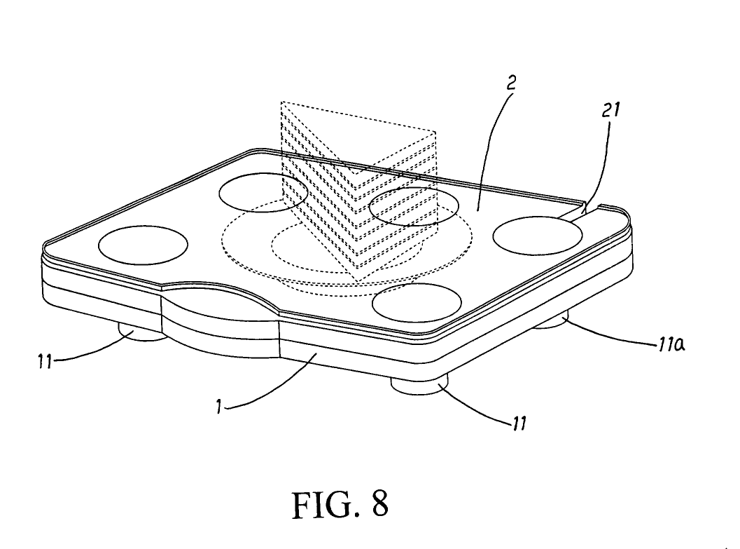

Referring to FIGS. 3 to 6, the cockroach-preventing seat of the present invention is illustrated. The cockroach-preventing seat includes a seat body 1 and a cover 2. The bottom of the seat body 1 has a plurality of legs 11. A periphery of each leg 11 is formed with a plurality of circled stepped surfaces 12 around the leg 11. A plurality of conductive pieces 13 are installed around each legs 11 one by one. The conductive pieces 13 are locked to the stepped surfaces 12 by screws 14. The nut 15 of each screw 14 located above the seat body 1 is used as a joint to be connected to a controller 16 for supplying power. Thus, a cockroach-preventing seat from placing foods is formed, as illustrated in FIG. 8. At least one leg 11a of the legs at a bottom of the seat body 1 is hollowed and internal thereof has a plug 17. Thereby, when an electric device 3 is placed upon the cover 2, as shown in the FIGS. 7, 9, a power wire 31 of the electric device 3 will pass through the slot 21 from a lateral side of the cover 2 and through the central hole of the plug 17 so as to be clamped therein. Then the plug 17 is inserted into the leg 11a in force so that the power wire is out of the bottom of the leg 11a. Thereby, by the design of the leg 11a and the plug 17, the cockroach will not enter into the seat of the present invention and the power wire 31 of the electric device 3 may be arranged in a preferred way.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A cockroach-preventing seat comprising a seat body and a cover arranged upon the seat body; wherein a bottom of the seat body has a plurality of legs; a periphery of each leg is formed with a plurality of stepped surfaces around the leg; a plurality of conductive pieces are installed around each legs one by one; the conductive pieces are locked to the stepped surfaces; power is input from a joint on the seat body; at least one selected leg of the legs at a bottom of the seat is hollowed and an internal of the selected leg has a plug; thereby, when an electric device is placed upon the cover; a power wire of the electric device passes through a slot in a lateral side of the cover and through a central hole of the plug so as to be clamped therein; then the plug is inserted into the selected leg in force so that the power wire is out of the bottom of the selected leg; thereby, by the design of the leg and the plug, cockroaches will not enter into the seat body along the electric wire.

2. The cockroach-preventing seat as claim in claim 1, wherein the stepped surfaces are concentric around the leg and the conductive pieces are circular piece.

3. The cockroach-preventing seat as claim in claim 1, wherein the conductive pieces are locked to the stepped surfaces by screws; a nut of each screw located above the seat is used as a joint for supplying power.
